(19) United States
(12) Patent Application Publication
(10) Pub. No.: US 2020/0124717 A1
(43) Pub. Date: Apr. 23, 2020

(54) LOCALIZING TARGETS IN A DISTRIBUTED RADAR ENVIRONMENT BASED ON CORRELATED BLOCKING LIKELIHOOD

(71) Applicant: King Abdulaziz City for Science and Technology, Riyadh (SA)

(72) Inventors: Hatim M. Behairy, Riyadh (SA); Sundar Aditya, Los Angeles, CA (US); Andreas F. Molisch, Los Angeles, CA (US)

(73) Assignee: University of Southern California, Los Angeles, CA (US)

(21) Appl. No.: 16/163,933

(22) Filed: Oct. 18, 2018

(51) Int. Cl. G01S 13/78; G01S 13/88; G01S 7/02; G06Q 10/08

(52) U.S. Cl. CPC G01S 13/78; G01S 13/88; G01S 2013/0281; G06Q 10/087; G01S 7/026

(57) ABSTRACT

A method may include receiving radar data from a plurality of TX-RX pairs (TRPs); generating a plurality of first ellipses representing a first portion of the received radar data; determining a blocking likelihood at a point of intersection between the plurality of first ellipses; generating a new or additional ellipse representing a second portion of the received radar data; and updating, based on generating the new or additional ellipse, the blocking likelihood at the point of intersection between the first plurality of ellipses.

### FIELD OF THE INVENTION

The invention relates to localizing targets in a distributed radar environment, and more particularly, to localizing targets in a distributed radar environment based on correlated blocking likelihood.

### BACKGROUND

Accurate indoor radar solutions can support a multitude of applications, ranging from providing location-based advertising for users in a shopping mall to better solutions for tracking inventory in a warehouse. Typically, multiple targets are present in which many or all of these targets may have very similar or nearly identical radar signatures. For example, from the perspective of radar devices, passive objects and/or individuals may appear similar in terms of size, shape and material. Thus, these mobile devices reflect radio waves similarly as well and hence, it may be difficult to distinguish between two different targets, thereby making localization difficult. In addition, each transmitter (TX) and receiver (RX) in a radar network may be equipped with a single antenna only, for reasons of cost and energy efficiency. In such cases, the radar cannot determine target locations based on direction of arrival (e.g., assuming that only signal propagation time is available for triangulating the target locations).

Localizing indoor targets may also be difficult and/or inaccurate, for example, because targets can be blocked by non-target scatterers such as walls, furniture, etc. Also, scatterers give rise to multipath (indirect paths or IPs) which need to be distinguished from direct line-of-sight paths (DPs) in order to accurately localize the targets. Further, accurately identifying all the DPs corresponding to a particular target, i.e., matching, can be difficult and/or inaccurate (e.g., since all the targets may have the same or similar radar signature). An incorrect matching of DPs to targets (e.g., when a DP is incorrectly matched to the wrong target) would yield erroneous target locations.

### SUMMARY

In an aspect of the invention, a method includes receiving, by a computing device, radar data from a plurality of TX-RX pairs (TRPs); generating, by the computing device, a plurality of first ellipses representing a first portion of the received radar data; determining, by the computing device, a blocking likelihood at a point of intersection between the plurality of first ellipses; generating, by the computing device, a new or additional ellipse representing a second portion or remainder of the received radar data; and updating, by the computing device based on generating the new or additional ellipse, the blocking likelihood at the point of intersection between the first plurality of ellipses.

In an aspect of the invention, there is a computer program product for identifying target locations in a distributed radar system. The computer program product includes a computer readable storage medium having program instructions embodied therewith, the program instructions executable by a computing device to cause the computing device to: select two of a plurality of TX-RX pairs (TRPs) in the distributed radar system; generate a plurality of first ellipses representing radar data received from the selected TRPs; determine a blocking likelihood at a point of intersection between the plurality of first ellipses; generate a new or additional ellipse representing radar data received from an additional TRP of the plurality of TRPs; and update, based on generating the new or additional ellipse, the blocking likelihood at the point of intersection between the first plurality of ellipses.

In an aspect of the invention, a system includes a CPU, a computer readable memory and a computer readable storage medium associated with a computing device; program instructions to generate a plurality of first ellipses representing multipath components (MPCs) extracted from a plurality of TX-RX pairs (TRPs); program instructions to determine a blocking likelihood at a point of intersection between the plurality of first ellipses; program instructions to generate a new or additional ellipse representing MPCs extracted from an additional TRP of the plurality of TRPs; program instructions to update, based on generating new or additional ellipse, the blocking likelihood at the point of intersection between the first plurality of ellipses; program instructions to determine correlated blocking information; and program instructions to store or output information regarding the blocking likelihood and the point of intersection between the first plurality of ellipses, where the correlated blocking information, the blocking likelihood, or the point of intersection between the first plurality of ellipses are used to localize one or more targets. The program instructions are stored on the computer readable storage medium for execution by the CPU via the computer readable memory.

### BRIEF DESCRIPTION OF THE DRAWINGS

The present invention is described in the detailed description which follows, in reference to the noted plurality of drawings by way of non-limiting examples of exemplary embodiments of the present invention.

FIGS. 1A and 1B illustrate an example environment in which the systems and/or methods of the present invention may be implemented.

FIG. 2 shows a diagram of ellipses representing multipath components (MPCs) extracted at TX-RX pairs (TRPs) in accordance with aspects of the present invention.

FIG. 3 illustrates an example of correlated blocking events between targets and TXs/RXs in accordance with aspects of the present invention.

FIGS. 4 and 5 illustrate an example implementation of determining target locations in a distributed radar environment in accordance with aspects of the present invention.

FIG. 6 shows an example flowchart for determining target locations in accordance with aspects of the present invention.

FIG. 7 shows an illustrative environment for implementing the steps in accordance with aspects of the invention.

### DETAILED DESCRIPTION

The invention relates to localizing targets in a distributed radar environment, and more particularly, to localizing targets in a distributed radar environment based on correlated blocking likelihood. Aspects of the present invention may include logic by which a single-antenna distributed multiple-input multiple-output (MIMO) radar system can simultaneously localize an unknown number of targets in an indoor or outdoor environment whose map may be unknown. In embodiments, aspects of the present invention may also include logic to determine the location of an unknown number of targets, all having the same or similar radar signature, in an unknown indoor or outdoor environment that poses blocking and/or multipath (non-target reflections).

In embodiments, potential target locations are identified from single-antenna radar devices, and blocking likelihoods are determined for these potential target locations. The blocking likelihoods relate to a probability that a potential target location is an actual target location. In embodiments, multiple-path components (MPCs) are extracted at each TX-RX pair, and analyzed for potential target locations. MPCs are analyzed iteratively (e.g., one at a time) and blocking likelihoods for each potential target location are updated each time an additional MPC is analyzed. As the blocking likelihoods are updated, potential targets may be eliminated from consideration as actual targets when the blocking likelihood no longer satisfies a threshold. Once all MPCs have been analyzed, the remaining potential target locations may be deemed to be actual target locations.

Aspects of the present invention may not require angle-of-arrival information from the targets to be available. Advantageously, considerable cost savings may be realized by employing single-antenna TXs and RXs instead of more expensive antenna arrays. Aspects of the present invention may also be advantageously combined with angular information, if available.

The present invention may be a system, a method, and/or a computer program product at any possible technical detail level of integration. The computer program product may include a computer readable storage medium (or media) having computer readable program instructions thereon for causing a processor to carry out aspects of the present invention. The computer readable storage medium can be a tangible device that can retain and store instructions for use by an instruction execution device.

The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

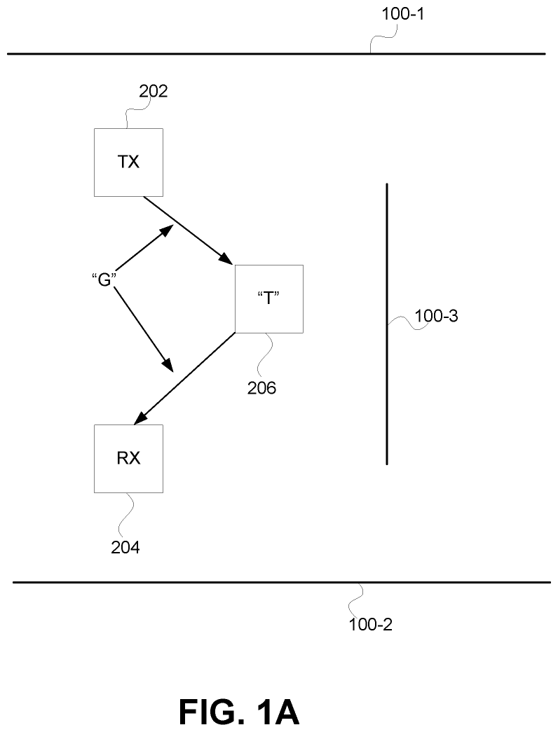

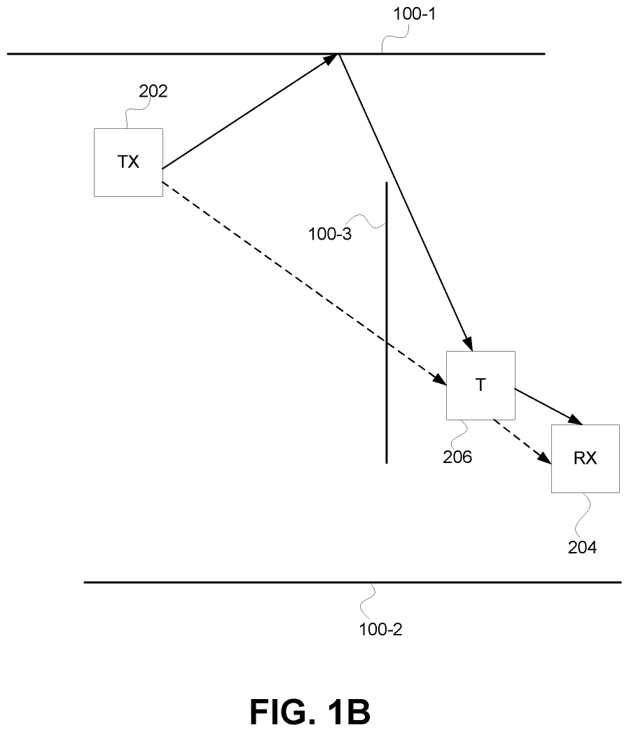

FIGS. 1A and 1B illustrate an example environment in which the systems and/or methods of the present invention may be implemented. As shown in FIG. 1A, a distributed MIMO radar system includes a transmitter (TX) 202, and a receiver (RX) 204. In a distributed MIMO radar system, any number of TXs 202 and RXs 204 may be implemented. In accordance with aspects of the present invention, the distributed MIMO radar system may localize any number of targets (e.g., determine the number of targets and estimate/refine the location of these targets). For example, the distributed MIMO radar system may localize the target “T” 206.

The TX 202 and RX 204 constitute a TX-RX pair (TRP). The example of FIG. 1A shows a single TRP, however, in embodiments, any number of TRPs may be implemented. As described herein, the TX 202 transmits signals that are received by the RX 204. As the TX 202 transmits signals, the signals are reflected off of targets, such as the target “T” 206. In an indoor environment, the signals may also reflect off of walls, such as walls 100-1, 100-2, and 100-3. In embodiments, having multiple TXs 202 and RXs 204, each TX 202 may transmit orthogonal signals so that the RXs 204 can distinguish between the TXs 202. Thus, a unique signal is obtained corresponding to each (TRP) that contains information about the target locations. For clarity, a two-dimensional (2-D) case is described, in which TXs, RXs, targets and scatterers are assumed to lie on a plane. However, aspects of the present invention are not so limited, and may be applied to a 3-D case.

Multipath components (MPCs) may be extracted at a TRP. For example, the received signals by the RX 204 may be represented as MPCs. In embodiments, certain received signals are filtered out or removed by a background cancellation technique. For example, a background cancellation technique may include removing signal strengths that are too weak (e.g., below a threshold). Additionally, or alternatively, a background cancellation technique may include removing MPCs that do not involve a reflection off of a target.

In accordance with embodiments of the present invention, extracted MPCs (e.g., MPCs from signals that have not been removed or filtered by a background cancellation technique) may represent a direct path (DP) to one or more targets which results when the target has line-of-sight (LoS) to both the TX and RX in question, an indirect path (IP) or a noise peak. In the example of FIG. 1A, a direct path is shown between both the TX 202 and the RX 204 and the target “T” 206. For example, the DP is shown by “G” in which signals transmitted by the TX 202 are reflected off of target “T” 206 to the RX 204 and when both the TX 202 and the RX 204 have a line-of-sight (LoS) to target “T” 206. Referring to FIG. 1B, an indirect path is shown between the TX 202 and the RX 204 and the target “T” 206. For example, signals transmitted by the TX 202 are reflected off of the wall 100-1 around the wall 100-3 and off of the target “T” 206 before being received by the RX 204. MPCs are extracted at the TRPs based on the received data by RX 204 (e.g., impulse responses from TX/RX pairs).

As described herein, each MPC gives rise to a time of arrival (ToA) estimate which, in turn, corresponds to a range (round-trip distance) estimate. At each TRP, there could, in general, be a collection of MPCs. Aspects of the present invention may identify all the DPs corresponding to a particular target.

Aspects of the present invention may localize a group of targets by obtaining the correct matching for a given collection of MPCs from all the TRPs in a distributed radar system. Once a matching is obtained, all the MPCs that are DPs to a particular target may be grouped. As described herein, each MPC gives rise to an ellipse with a TX and an RX at the foci of the ellipse. If an MPC happens to be a DP to a target, then the corresponding ellipse passes through the target location. Three or more such DP ellipses may determine the target location (e.g., triangulation). As described herein, the terms “ellipses” and “MPCs” may be used interchangeably.

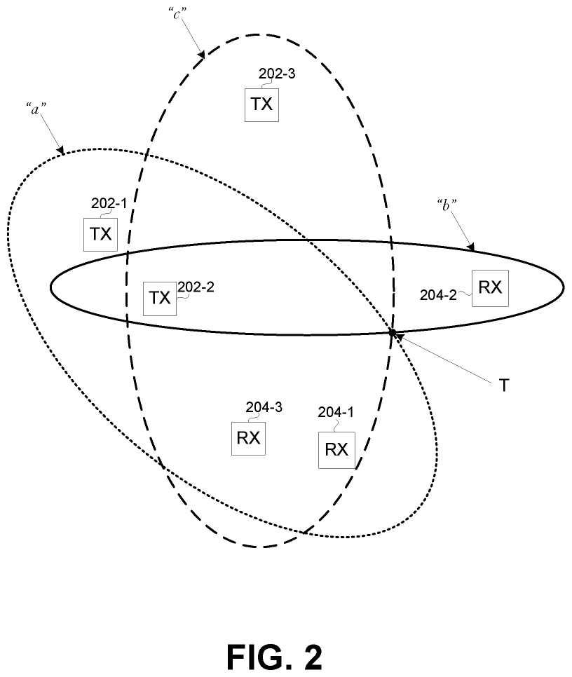

FIG. 2 shows a diagram of ellipses representing MPCs extracted at TRPs in accordance with aspects of the present invention. In the example of FIG. 2, three ellipses represent three MPCs extracted at three TRPs. For example, ellipse “a” represents the extracted MPC for TRP 1 (e.g., the TRP that includes a TX 202-1 and an RX 204-1). Ellipse “b” represents the extracted MPC for TRP 2 (e.g., the TRP that includes a TX 202-2 and an RX 204-2). Ellipse “c” represents the extracted MPC for TRP 3 (e.g., the TRP that includes a TX 202-3 and an RX 204-3). In the example shown in FIG. 2, a target location “T” may be determined as a location corresponding to a point in which all three ellipses intersect (e.g., triangulation). As described herein, an ellipse “intersection” may not necessarily be an exact point in which ellipses intersect. For example, aspects of the present invention may compensate for noise corruption in which multiple ellipses come relatively close to intersecting at a point. In embodiments, if multiple ellipses (e.g., three or more ellipses) are within a threshold distance of a particular point, a determination may be made that the particular point is considered to an intersection point, even if the ellipses are not exactly intersecting at the particular point.

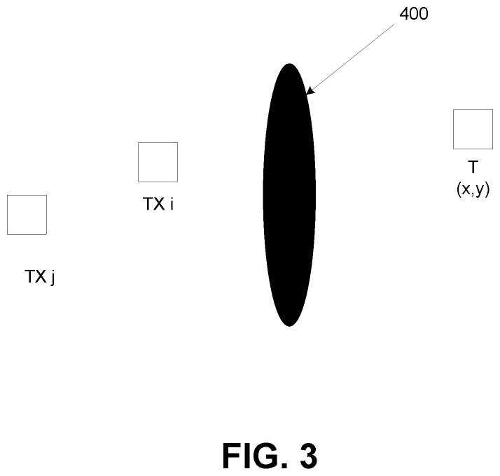

FIG. 3 illustrates an example of correlating blocking events between targets in accordance with aspects of the present invention. As shown in FIG. 3, various DP blocking events may not necessarily be independent. For example, if one of two TXs (e.g., TX j and TX i) have a LoS to a target (T), is highly likely that the other does as well. Similarly, if one of the TXs has no LoS to the target, it is highly likely that the other TX also has no LoS. In other words, the DP blocking probabilities for the different TX-RX pairs (TRPs) at a (potential) target location are, in general, correlated and the extent of correlation may depend on the relative positions of the TXs and RXs with respect to the target location. This is the phenomenon of correlated blocking and it can be used to improve the reliability of target localization in accordance with aspects of the present invention. As described in greater detail herein, modeling the correlation of DP blocking events is used to determine the blocking likelihood at a point of ellipse intersections. The blocking likelihood is used to make a final determination as to whether a target exists at a particular point of intersection.

As described herein, if one of two closely situated TXs has LoS to a target, then it is highly likely that the other does as well. Similarly, if one of the TXs has no LoS to the target, it is highly likely that the other TX also has no LoS. In other words, the DP blocking probabilities for the different TX-RX pairs (TRPs) at a (potential) target location are, in general, correlated and the extent of correlation may be a function of the relative positions of the TXs and RXs with respect to the target location. This is the phenomenon of correlated blocking and it can be used to improve the reliability of target localization in accordance with aspects of the present invention. Aspects of the present invention, as described in greater detail below, may extract MPCs from impulse responses at TRPs, estimate a probability of blockage between prospective target locations and the plurality of TRPs, and determine that a potential target location is an actual target locations based on the estimated probability of blockage.

As an example, assume that the i-th TRP has Nᵢ MPCs extracted from its signal. Let rᵢⱼ denote the range of the j-th extracted MPC for the i-th TRP and let rᵢ=[rᵢ₁, rᵢ₂, . . . , r_{iN}_{ᵢ}]∈R^{N}^{ᵢ} denote the vector of those range estimates. Let r=[r₁, r₂, . . . , rₗ]∈R^{N}^{₁}^{N}^{₂}^{. . . N}^{_{I}} denote the stacked vector of range estimates from all TRPs. If rᵢⱼ is a DP corresponding to a target at (xₜ, yₜ), then let ƒ_{DP}(rᵢⱼ|xₜ, yₜ) denote the conditional probability density function (pdf) of rᵢⱼ given (xₜ, yₜ). Similarly, let {ƒ_{IP,s}(rᵢⱼ|xₜ, yₜ, uₘ, vₘ):s∈S} denote the set of conditional IP pdfs (indexed by an index set S) representing all possible IPs involving a target at (xₜ, yₜ), a scatterer at (uₘ, vₘ), and the i-th TRP.

The following example equations may model the DP blocking events, although other models can also be used. In particular, correlated blocking can be used for localization. In the below equations, {(xₜ, yₜ):t=1, . . . , T} are target locations, and T is the number of targets. The number of targets is unknown in which aspects of the present invention may determine the number of targets as well as the target locations. However, knowledge of the number of targets can be used to further improve the accuracy of localization, but knowledge of the number of targets is not necessary.

Let the number of targets and scatterers be denoted by T and M, respectively. One approach to target localization is to account for every MPC. For this, the following variables are defined:

$$\begin{matrix}{k}_{it} = \{ \begin{matrix}1 , if t \text{-} th target is NOT blocked w . r . t the i \text{-} th TRP \\ 0 , else\end{matrix} & ( 1 ) \\ {g}_{imts} = \{ \begin{matrix}1 , if there exists an IP between the i \text{-} th TRP , t \text{-} th \\ target and m \text{-} th scatterer of the s \text{-} th kind \\ 0 , else\end{matrix} & ( 2 )\end{matrix}$$

The values of kᵢₜ and {gᵢₘₜₛ}, may depend on the environment and may be estimated from r, if the map of the environment is unavailable. This may be accomplished by defining the following decision variables that help determine if an MPC rᵢⱼ is a DP, IP or noise peak,

$$\begin{matrix}{\tilde{k}}_{ijt} = \{ \begin{matrix}1 , if {r}_{ij} is a DP to the t \text{-} th target \\ 0 , else\end{matrix} & ( 3 ) \\ {\tilde{g}}_{ijmts} = \{ \begin{matrix}1 , if {r}_{ij} is an IP of the s \text{-} th kind between the \\ t \text{-} th target and m \text{-} th scatterer \\ 0 , else\end{matrix} & ( 4 ) \\ {\tilde{z}}_{ij} = \{ \begin{matrix}1 , if {r}_{ij} is a noise peak \\ 0 , else\end{matrix} & ( 5 )\end{matrix}$$

The estimates of kᵢₜ and gᵢₘₜₛ, denoted by \hat{k}ᵢₜ and ĝᵢₘₜₛ, respectively, may then be derived as follows:

\hat{k}ᵢₜ=Σⱼ\tilde{k}ᵢⱼₜ (6)

ĝᵢₘₜₛ=Σⱼ\tilde{g}ᵢⱼₘₜₛ (7)

Let k, g, \hat{k}, ĝ, \tilde{k}, \tilde{g} and \tilde{z} denote the vector of all kᵢₜ, gᵢₘₜₛ, \hat{k}ᵢₜ, ĝᵢₘₜₛ, \tilde{k}ᵢⱼₜ, \tilde{g}ᵢₘₜₛ and \tilde{z}ᵢⱼ, respectively. Let Θₜₐᵣ={(xₜ,yₜ):t=1, . . . , T} and Θ_{sc}={(uₘ, vₘ):1, . . . , M} denote the collection of target and scatterer locations, respectively, and let \tilde{p}_{dec}=[\tilde{k}, \tilde{g}, \tilde{z}] denote the vector of all decision variables. The location of all targets and scatterers can be formulated as a Bayesian estimation problem (P1) in the following manner.

$$\begin{matrix}P 1 \text{:} {maximize}_{T , M , {\tilde{p}}_{dec} , {Θ}_{tar} , {Θ}_{sc}} f ( r \vert {\tilde{p}}_{dec} , {Θ}_{tar} , {Θ}_{sc} , k , g ) ℙ ( \hat{k} , \hat{g} \vert {Θ}_{tar} , {Θ}_{sc} , k , g ) & ( 8 ) \\ ℙ ( k , g \vert {Θ}_{tar} , {Θ}_{sc} ) f ( {Θ}_{tar} , {Θ}_{sc} ) & \\ subject to {\tilde{k}}_{ijt} , {\tilde{g}}_{ijmts} , {\hat{k}}_{it} , {\hat{g}}_{imts} ∈ \{ 0 , 1 \} , ∀ i , j , t , m & ( 9 ) \\ {\sum }_{j , t} {\tilde{k}}_{ijt} + {\sum }_{j , m , t , s} {\tilde{g}}_{imts} + {\sum }_{j} {\tilde{z}}_{ij} \geq {N}_{i} & ( 10 ) \\ {\sum }_{j} {\tilde{k}}_{ijt} = {\tilde{k}}_{it} & ( 11 ) \\ {\sum }_{j} {\tilde{g}}_{ijmts} = {\tilde{g}}_{imts} , s ∈ S & ( 12 )\end{matrix}$$

A detailed explanation of all the terms and constraints in (8)-(12) is provided below:

(a) The term [symbol] (k, g|Θₜₐᵣ, Θ_{sc}) captures the geometry of the environment, such as the blocked TRPs for each target, the IPs (if any) between a given TRP, target and scatterer etc. Let (cᵢ, dᵢ) and (aᵢ, bᵢ) denote, respectively, the location of the TX and RX corresponding to the i-th TRP and let Θ_{TX}={(cᵢ, dᵢ):i=1, . . . , I} and Θ_{RX}={(aᵢ, bᵢ):i=1, . . . , I} denote the collection of TX and RX locations, respectively. The set of variables Θₑₙᵥ={Θ_{TX}, Θ_{RX}, Θₜₐᵣ, Θ_{sc}} denote the environment and the values of k and g are deterministic functions of Θₑₙᵥ, denoted by k^{(det)}(Θₑₙᵥ) and g^{(det)}(Θₑₙᵥ), respectively. Hence,

$$ℙ ( k , g \vert {Θ}_{tar} , {Θ}_{sc} ) = \{ \begin{matrix}1 , if k = {k}^{( det )} ( {Θ}_{env} ) and g = {g}^{( det )} ( {Θ}_{env} ) \\ 0 , else\end{matrix} \qquad ( 13 )$$

(b) The estimates \hat{k}ᵢₜ, ĝᵢₘₜₛ may differ from their respective ground truths, kᵢₜ, gᵢₘₜₛ due to noise or IPs. The probability of such events is captured by the following term:

[symbol]

(\hat{k}, ĝ|Θₜₐᵣ, Θₜₐᵣ, Θ_{sc}, k, g)= [symbol] (\hat{k}, ĝ|k^{(det)}(Θₑₙᵥ), g^{(det)}(Θₑₙᵥ)) (14)

Further, given the assumption that the estimate \hat{k}ᵢₜ, (or ĝᵢₘₜₛ) is conditionally independent of other estimates, given the ground truth kᵢₜ, (or gᵢₘₜₛ), the result is:

[symbol]

(\hat{k}, ĝ|k^{(det)}(Θₑₙᵥ), g^{(det)}(Θₑₙᵥ))=Πᵢₘₜₛ [symbol] (\hat{k}ᵢₜ|\hat{k}ᵢₜ^{(det)}(Θₑₙᵥ))· [symbol] (ĝᵢₘₜ|ĝᵢₘₜ^{(det)}(Θₑₙᵥ)) (15)

(c) (\tilde{p}_{dec} is a sufficient statistic for estimating k and g. Hence,

ƒ(r|\tilde{p}_{dec}, Θₜₐᵣ, Θ_{sc}, k, g)=ƒ(r|\tilde{p}_{dec}, Θₜₐᵣ, Θ_{sc}). Thus,

$$f ( r \vert {\tilde{p}}_{dec} , {Θ}_{tar} , {Θ}_{sc} , k , g ) = f ( r \vert {\tilde{p}}_{dec} , {Θ}_{tar} , {Θ}_{sc} ) = {f}_{DP} ( r \vert {Θ}_{tar} , \tilde{k} ) {f}_{IP} ( r \vert {Θ}_{tar} , {Θ}_{sc} , \tilde{g} ) {f}_{n} ( r \vert \tilde{z} ) \qquad ( 16 )$$

where ƒ_{DP}(r|Θₜₐᵣ, \tilde{k}) denotes the joint DP distribution of r, given Θₜₐᵣ and
\tilde{k}; ƒ_{IP}(r|ƒₜₐᵣ, Θ_{sc}, \tilde{g}) denotes the joint IP distribution of r, given Θₜₐᵣ, Θ_{sc} and \tilde{g}; and
ƒₙ(r|\tilde{z}) denotes the joint noise-peak distribution of r, given \tilde{z}. Further, if the noise on each rᵢⱼ is independent, the right-hand side of (18) decomposes into product form.

ƒ_{DP}(r|Θₜₐᵣ, \tilde{k})ƒ_{IP}(r|Θₜₐᵣ, Θ_{sc}, \tilde{g})ƒₙ(r|\tilde{z})=Π_{i, j, m, t, s}(ƒ_{DP}(rᵢⱼ|xₜ, yₜ))^{\tilde{k}}^{ᵢⱼₜ}(ƒ_{IP,s}(rᵢⱼ|xₜ, yₜ, uₘ, vₘ))^{\tilde{g}}^{ᵢⱼₘₜₛ}ƒₙ(rᵢⱼ)^{\tilde{z}ij} (17)

While P1 may capture the problem of target localization in the most general case, an alternative approach to localization that accounts for only the DPs may be derived from P1 by retaining those terms involving just DPs in (8)-(12). This approach may be especially useful when the map of the environment is unknown and gives rise to the following problem, P2, which is also a Bayesian estimation problem:

$$\begin{matrix}P 2 \text{:} {maximize}_{T , \tilde{k} , {Θ}_{tar}} {f}_{DP} ( r \vert {Θ}_{tar} , \tilde{k} ) ℙ ( \hat{k} \vert k , {Θ}_{tar} ) ℙ ( k \vert {Θ}_{tar} ) & ( 18 ) \\ subject to & \\ {\tilde{k}}_{ijt} , {\tilde{k}}_{it} ∈ \{ 0 , 1 \} , ∀ i , j , t , m & ( 19 ) \\ {\sum }_{j} {\tilde{k}}_{ijt} = {\tilde{k}}_{it} & ( 20 )\end{matrix}$$

which the scatterers are placed at random.

The vector kₜ=[k₁ₜ, . . . , k_{It}] consists of dependent Bernoulli random variables (as described herein with respect to FIG. 3) which represent the ground truth of the blocking observed at target t and is thus referred to as the blocking vector at (xₜ, yₜ). Note that k=[k₁, . . . , k_{T}] and therefore, [symbol] (k|Θₜₐᵣ)= [symbol] (k₁; . . . ; k_{T}). In general, two or more blocking vectors may also be dependent as nearby targets can experience similar blocking. Thus, the joint distribution [symbol] (k₁; . . . ; k_{T}) may capture the correlated blocking in its entirety. Consequently, target-by-target localization may not be optimal, in general. In terms of the blocking vector terminology, P2 may be re-written as follows:

$$\begin{matrix}P 2 \text{:} {maximize}_{T , \tilde{k} , {Θ}_{tar}} {f}_{DP} ( r \vert {Θ}_{tar} , \tilde{k} ) ℙ ( {\hat{k}}_{1} ; … ; {\hat{k}}_{T} \vert {k}_{1} ; … ; {k}_{T} ) ℙ ( {k}_{1} ; … ; {k}_{T} ) & ( 21 ) \\ subject to & \\ {\tilde{k}}_{ijt} , {\tilde{k}}_{it} ∈ \{ 0 , 1 \} , ∀ i , j , t , m & ( 22 ) \\ {\sum }_{j} {\tilde{k}}_{ijt} = {\tilde{k}}_{it} & ( 23 )\end{matrix}$$

While P2 captures the problem of target localization using correlated blocking in the most general case, a number of simplifications may be made based on real-world scenarios and/or for ease of computation. These are detailed below.

For ease of computation, independent blocking vectors at distinct locations may be assumed, although this assumption may not always be true, i.e.,

[symbol]

(k₁; . . . ; k_{T})˜Πₜ [symbol] (kₜ) (24)

Given kᵢₜ, it may be assumed that \hat{k}ᵢₜ is conditionally independent of all other variables. As a result,

[symbol]

(\hat{k}₁; . . . ; \hat{k}_{T}|k₁; . . . ;k_{T})=Π_{i,t} [symbol] (\hat{k}ᵢₜ|kᵢₜ) (25)

Combined with the previous assumption, this yields the following simplification.

z÷(\hat{k}₁; . . . ; \hat{k}_{T}|k₁; . . . ; k_{T}) [symbol] (k₁; . . . ; k_{T})=Πₜ [symbol] (\hat{k}ₜ) (26)

The additive white Gaussian noise (AWGN) assumption holds for most real-world electronic receivers. As a result,

$$\begin{matrix}{f}_{DP} ( r \vert {Θ}_{tar} , \tilde{k} ) = {\prod }_{i , j , t} {( \frac{1}{\sqrt{2 π} σ} )}^{{\overline{k}}_{ijt}} exp ( - \frac{{{\tilde{k}}_{ijt} ( {r}_{ij} - {r}_{i} ( {x}_{t} , {y}_{t} ) )}^{2}}{2 {σ}^{2}} ) & ( 27 ) \\ where & \\ {r}_{i} ( {x}_{t} , {y}_{t} ) = \sqrt{{( {x}_{t} - {c}_{i} )}^{2} + {( {y}_{t} - {d}_{i} )}^{2}} + \sqrt{{( {x}_{t} - {a}_{i} )}^{2} + {( {y}_{t} - {b}_{i} )}^{2}} & ( 28 )\end{matrix}$$

σ² denotes the noise variance and rᵢ(xₜ, yₜ) denotes the range to the t-th target from the i-th TRP.

Based on the above assumptions, P2 can be reduced to the following optimization problem P3

$$\begin{matrix}{maximize}_{T , \overline{k} , {Θ}_{tar}} [ \frac{1}{{σ}^{2}} ( {\sum }_{i , j , t} {{\tilde{k}}_{ijt} ( {r}_{ij} - {r}_{i} ( {x}_{t} , {y}_{t} ) )}^{2} ) - ( {\sum }_{i , j , t} {\tilde{k}}_{ijt} ) log \sqrt{2 π} σ ] - {\sum }_{t} log ℙ ( {\hat{k}}_{t} ) & ( 29 ) \\ subject to {\tilde{k}}_{ijt} , {\tilde{k}}_{it} ∈ \{ 0 , 1 \} , ∀ i , j , t , m & ( 30 ) \\ {\sum }_{j} {\tilde{k}}_{ijt} = {\tilde{k}}_{it} & ( 31 )\end{matrix}$$

Aspects of the prevent invention include techniques for solving P3.

A blocking vector kₜ=[k₁ₜ . . . k_{It}] for the t-th target can be obtained by stacking all the kᵢₜ's together, in which I denotes the number of TRPs. This may be a random vector comprising of dependent Bernoulli random variables, since the blocking events are correlated, in general. The random vector may have a probability distribution, which is a function of a given distributed radar environment. This distribution, which may be empirical, may be known apriori so that the environment-specific blocking characteristics can be used in order to obtain more accurate location estimates for the targets.

As an example, let [symbol] (kₜ) represent the probability of obtaining a blocking vector kₜ. A blocking likelihood of kₜ may be defined as equal to −log [symbol] (kₜ). The blocking likelihood encapsulates the blocking characteristics of the given distributed radar environment.

In embodiments, the vector kₜ may be based on matching determinations. In embodiments, if a DP exists between a target and a TRP, then both the TX and RX corresponding to that TRP have a LoS to the target. Thus, blocking information may be derived from a matching determination.

As described herein, blocking vectors and likelihoods are determined for potential target locations identified by ellipse intersections. For example, assume that three of four ellipses intersect at a particular point. Further, assume that the ellipses extracted from TRP 1, TRP 2, and TRP 3 intersect at the particular point, but the ellipse from TRP 4 does not. Given this assumption, the blocking vector at this intersection is [1 1 1 0] in which the order of the values in the vector represent intersections by the ellipses from TRP 1, TRP 2, TRP 3, and TRP 4, respectively. As another example, if the ellipses extracted from TRP 1, TRP 3, and TRP 4 intersected at a point, but the ellipse extracted from TRP 2 does not intersect at the point, the blocking vector at the point is [1 0 1 1]. That is, a value of 1 represents the existence of a DP from the corresponding TRP at the potential target location (e.g., an ellipse intersection). Blocking likelihoods are determined based on the blocking vector.

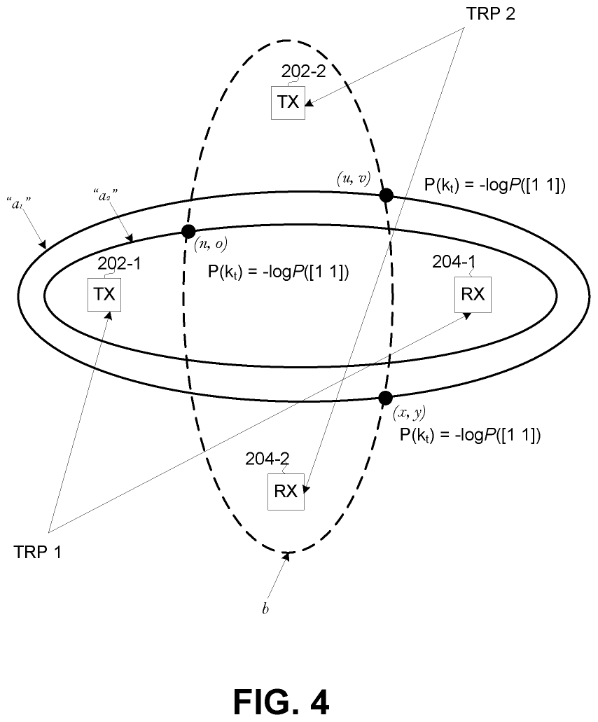

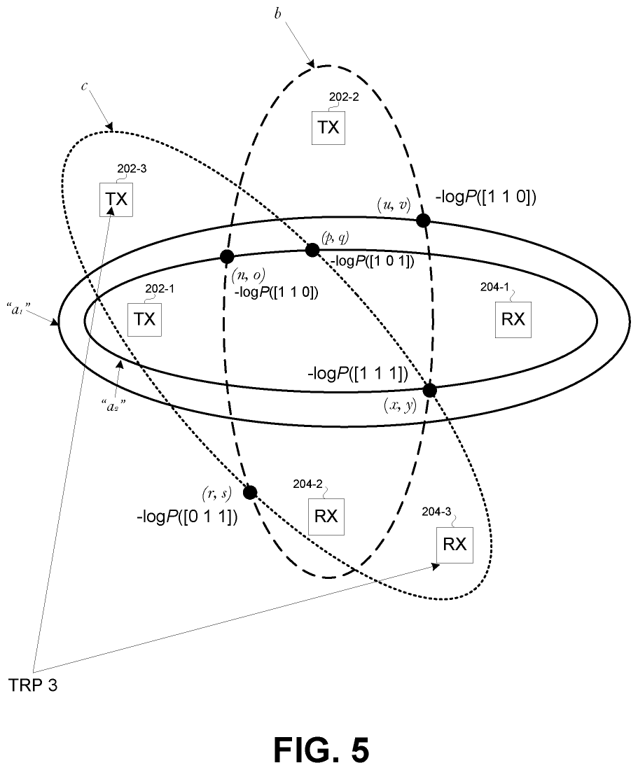

FIGS. 4 and 5 illustrate an example implementation of determining target locations in a distributed radar environment in accordance with aspects of the present invention. As shown in FIG. 4, an ellipse is generated for each MPC extracted at each TRP. As described herein, a single TRP may receive multiple signal peaks. Thus, multiple MPCs may be extracted for a single TRP For example, as shown in FIG. 4, ellipses “a₁” and “a₂” represent multiple MPCs at TRP 1 (e.g., a TRP consisting of TX 202-1 and RX 204-1). As further shown in FIG. 4, an ellipse “b” is shown for the MPC extracted at TRP 2 (e.g., a TRP consisting of TX 202-2 and RX 204-2).

In embodiments, a target may be assumed to be present at the point in which the ellipses intersect. Further, it may be assumed that the intersecting ellipses are all DPs to the prospective target. As shown in FIG. 4, blocking likelihoods are determined at ellipse intersection points (n, o), (u, v), and (x, y) . For example, the blocking likelihoods are −log [symbol] (k (n, o)=[1 1]), −log [symbol] (k (u, v)=[1 1]), −log [symbol] (k (x, y)=[1 1]) at points (n, o), (u, v), and (x, y) since these points lie on ellipses for both TRP 1 and TRP 2. Even if two points have the same blocking vector, the blocking likelihood can change since the probability distribution of the blocking vector k is different from point to point. Specifically, for point (n, o), an ellipse associated with TRP 1 (e.g., ellipse “a₂”) intersects with the ellipse associated with TRP 2 (e.g., ellipse “b”) at point (n, o). Thus, the blocking vector for point (n, o) is [1 1] since the point (n, o) lies on an ellipse for TRP 1 and TRP 2. For point (u, v), an ellipse associated with TRP 1 (e.g., ellipse “a₁”) intersects with the ellipse associated with TRP 2 (e.g., ellipse “b”) at the point (u, v). Thus, the blocking vector for point (u, v) is [1 1] since the point (u, v) lies on an ellipse for TRP 1 and TRP 2. For point (x, y), an ellipse associated with TRP 1 (e.g., ellipse “a₁”) intersects with the ellipse associated with TRP 2 (e.g., ellipse “b”) at point (x, y). Thus, the blocking vector for point (x, y) is [1 1] since the point (x, y) lies on an ellipse for TRP 1 and TRP 2. For clarity, blocking likelihoods are shown at points (n, o), (u, v), (x, y). However, in practice, blocking likelihoods may be determined at all points of intersection.

Referring to FIG. 5, an additional ellipse is subsequently generated based on an MPC extracted from an additional TRP of the distributed radar environment. For example, the ellipse “c” represents an MPC extracted at TRP 3. Based on generating ellipse “c” the blocking likelihoods at all the ellipse intersections are updated. For example, the blocking likelihoods at points (n, o) and (u, v) are updated to −log [symbol] (k(n, o)=[1 1 0]) since points (n, o) and (u, v) lie on an ellipse for TRP 1 (e.g., ellipse “a₂” and “a₁” respectively), the ellipse for TRP 2 (e.g., ellipse “b”) but not on the ellipse for TRP 3 (e.g., ellipse “c”). The blocking likelihood at point (x, y) is updated to −log [symbol] (k (x, y)=[1 1 1]) since point (x, y) lies on ellipses associated with TRP 1, TRP 2, and TRP 3. As further shown in FIG. 5, the blocking likelihood for new intersection points are determined (e.g., the points (p, q) and (r, s)). For example, the blocking likelihood at point (p, q) is −log [symbol] (k (p, q)=[1 0 1]) since point (p, q) lies on an ellipse of TRP 1 (e.g., ellipse “a₂”) and the ellipse of TRP 3 (e.g., ellipse “c”).

In a similar manner as described herein, ellipses for additional MPCs extracted at additional TRPs in the distributed radar environment are generated iteratively (e.g., one at a time). As additional ellipses are generated, the blocking likelihoods for existing ellipse intersections are updated, and the blocking likelihoods for new intersections are determined. As the blocking likelihoods are updated, the intersections whose likelihoods drop below a particular threshold μ may be eliminated from consideration as a target location. After all ellipses have been considered, the ellipse intersections having blocking likelihoods satisfying the threshold are determined as the target locations. In the example of FIG. 5, a conclusion is not yet made that a target is present at point (x, y), rather, the blocking likelihood at point (x, y) is updated. Conclusions regarding the target locations may be made once all ellipses have been considered.

In embodiments, the threshold μ may be selected based on a trade-off between accuracy and comprehensiveness. For example, satisfying a low blocking threshold would indicate that the identified targets are more likely to be actual targets. However, a low blocking threshold may cause actual targets to be erroneously eliminated from consideration as targets. A high blocking threshold would reduce the chances of erroneously eliminating actual targets from consideration, but may yield a greater number of false positives in which non-targets are identified as targets. Knowledge of the number of targets or estimating the number of targets using another technique can be used advantageously to reduce the number of false positives.

Blocking likelihoods may be determined for all points of intersection. In embodiments, TRPs are not limited to the TRPs shown in FIGS. 4 and 5. For example, one TRP may consist of TX 202-1 and RX 204-1, and another TRP may consist of TX 202-1 and 204-2. Ellipses for MPCs extracted at all TRPs in a distributed radar environment may be considered when identifying target locations and corresponding blocking likelihoods.

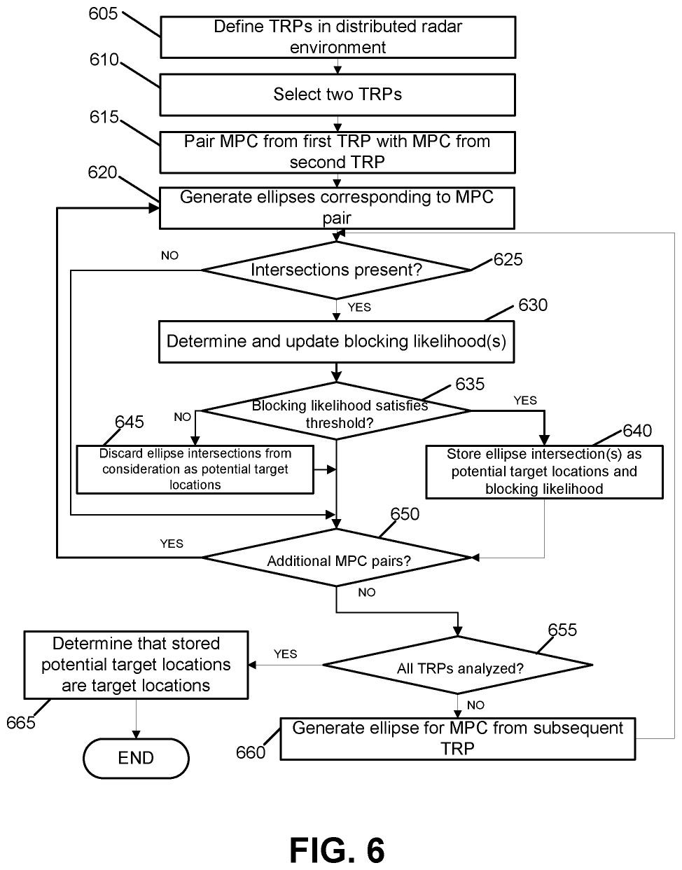

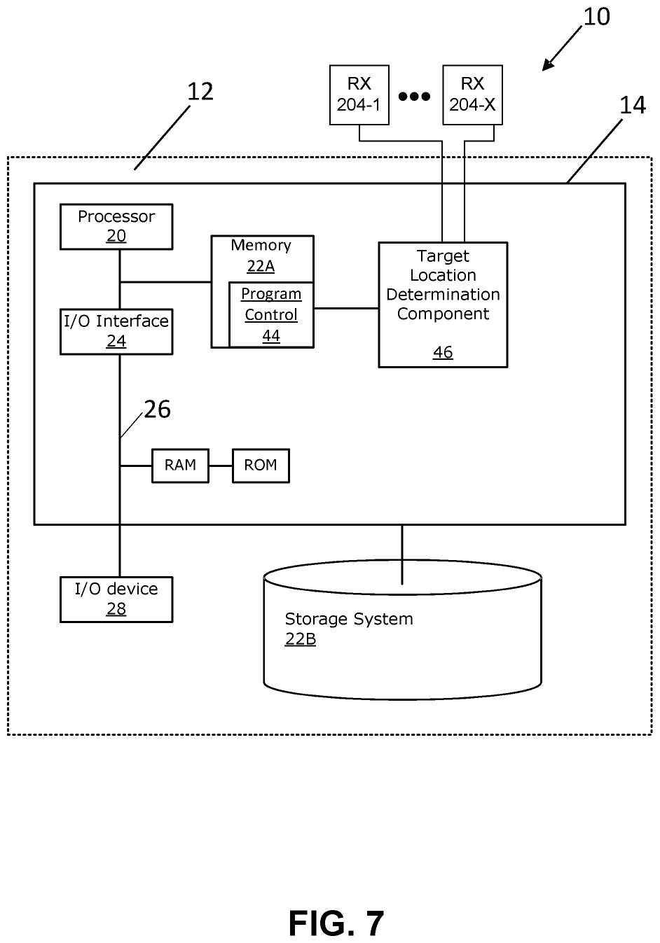

FIG. 6 shows an example flowchart for determining target locations in accordance with aspects of the present invention. The steps of FIG. 6 may be implemented by one or more computing devices as shown for example, in FIG. 7. As noted herein, the flowchart illustrates the architecture, functionality, and operation of possible implementations of systems, methods, and computer program products according to various embodiments of the present invention.

As shown in FIG. 6 at step 605, TRPs in a distributed radar environment are defined. For example, TRPs are defined based on the TXs and RXs present in the distributed radar environment. As an example, assume that the distributed radar environment includes TX 1, RX 1, TX 2, RX 2, TX 3, and RX 3. Given this assumption there may be a total of nine TRPs as shown in the below table 1:

TABLE 1
Example TRP definitions

| TRP | TX | RX |
|---|---|---|
| TRP 1 | TX 1 | RX 1 |
| TRP 2 | TX 1 | RX 2 |
| TRP 3 | TX 1 | RX 3 |
| TRP 4 | TX 2 | RX 1 |
| TRP 5 | TX 2 | RX 2 |
| TRP 6 | TX 2 | RX 3 |
| TRP 7 | TX 3 | RX 1 |
| TRP 8 | TX 3 | RX 2 |
| TRP 9 | TX 3 | RX 3 |

At step 610, two TRPs are selected. In embodiments, the two TRPs may be selected based on a pre-determined processing order. As an example, assume that TRP 1 and TRP 2 are selected.

At step 615, an MPC extracted from a first TRP (e.g., TRP 1) is paired with an MPC extracted from a second TRP (e.g., TRP 2). At step 620, ellipses corresponding to the MPCs are generated.

At step 625, a determination is made as to whether any intersections are present between the ellipses. For example, the ellipses are analyzed and searched for intersections. If intersections are present (step 625—YES), blocking likelihoods for these intersections is determined at step 630. For example, as described above, the blocking likelihoods are determined using the expression −log [symbol] (kₜ).

At step 635, a determination is made as to whether each blocking likelihood satisfies a threshold. For example, as described herein, the value of the blocking likelihood is compared to a pre-defined threshold μ. If the blocking likelihood satisfies the threshold (step 635—YES), information is stored indicating that the ellipse intersection is determined to be a potential target location at step 640. Also, the blocking likelihood for the ellipse intersection is stored. If, on the other hand, the blocking likelihood does not satisfy the threshold (step 635—NO), the ellipse intersection is discarded from consideration as a potential target location at step 645. For example, the ellipse intersection may be cleared from memory, or an indication may be stored that the ellipse intersection is no longer considered a potential target. Additionally, or alternatively, another technique may be used to indicate the determination that the ellipse intersection is not a potential target.

In either case, the process continues to step 650 in which a determination is made as to whether additional MPC pairs are present at the TRPs currently being analyzed. Also, the process may proceed to step 650 in the event no intersections were present at step 625 (step 625—NO). If additional MPC pairs are present (step 650—YES), the process may return to step 620 in which ellipses corresponding to the additional MPC pairs are generated. If additional MPC pairs are not present (step 650—NO), the process may continue to step 655 in which a determination is made as to whether all of the defined TRPs (e.g., as defined at step 605) have been analyzed. For example, a TRP is considered to have been analyzed once all ellipses for all MPCs associated with the TRP have been generated, and once the blocking likelihood for any intersecting points on the ellipses have been determined.

If all the TRPs have not been analyzed (step 655—NO), the process may continue to step 660 in which ellipses corresponding to MPCs for a subsequent TRP are generated. The process may return to step 625 in which a determination is made as to whether intersections are present. When continuing to step 630 (e.g., at 625—YES), new blocking likelihoods are determined for new ellipse intersections that occur as a result of generating ellipses associated with the subsequent TRP. The process continues to step 635 in which a determination is made as to whether the blocking likelihoods (e.g., the updated blocking likelihoods and/or the newly generated blocking likelihoods) satisfy the threshold. For blocking likelihoods that do satisfy the threshold, information regarding these ellipse intersections are stored as potential target locations, while those ellipse locations whose blocking likelihoods do not satisfy the threshold are discarded. The process continues until all MPC pairs and all TRPs have been analyzed iteratively (e.g., one by one). Once all MPC pairs and all TRPs have been analyzed, the stored potential target locations that remain (e.g., that were not discarded throughout the process) are determined to be target locations at step 665. Information regarding the target locations may be output to a user via a display or message.

As described herein, a first portion of data from TRPs is analyzed (e.g., an initial set of ellipses are generated and blocking likelihoods at ellipse intersections are determined). A second portion of data from the TRPs is analyzed in an iterative manner, e.g., ellipses are generated one by one, and with each new ellipse, blocking likelihoods for new ellipse intersections are generated, and blocking likelihoods for existing ellipses are updated). Once all data from the TRPs has been analyzed (e.g., once all ellipses have been generated), any ellipse intersections whose blocking likelihoods satisfy the threshold may be determined to be the target locations.

FIG. 7 shows an illustrative environment 10 for managing the processes in accordance with the invention. To this extent, environment 10 includes a server 12 or other computing system that can perform the processes described herein. In particular, server 12 includes a computing device 14. The computing device 14 can be resident on a network infrastructure or computing device of a third party service provider (any of which is generally represented in FIG. 7).

The computing device 14 includes a processor 20 e.g., CPU), memory 22A, an I/O interface 24, and a bus 26. The memory 22A can include local memory employed during actual execution of program code, bulk storage, and cache memories which provide temporary storage of at least some program code in order to reduce the number of times code must be retrieved from bulk storage during execution. In addition, the computing device includes random access memory (RAM), a read-only memory (ROM), and an operating system (O/S).

The computing device 14 is in communication with external I/O device/resource 28 and storage system 22B. For example, I/O device 28 can comprise any device that enables an individual to interact with computing device 14 e.g., user interface) or any device that enables computing device 14 to communicate with one or more other computing devices using any type of communications link. The external I/O device/resource 28 may be for example, a handheld device, PDA, handset, keyboard etc. It should be understood that multiple RXs may be connected to the computing device 14 and the signal received from each RX is transferred to the computing device 14 which may execute the processes and analysis described herein to localize target locations (e.g., using the target location determination component 46), and display/store the results.

In general, processor 20 executes computer program code e.g., program control 44), which can be stored in memory 22A and/or storage system 22B. Moreover, in accordance with aspects of the invention, program control 44 controls a target location determination component 46, e.g., the processes described herein. For example, target location determination component 46 can implement the processes shown of FIGS. 1-6. The target location determination component 46 can be implemented as one or more program code in program control 44 stored in memory 22A as separate or combined modules. Additionally, the location determination component 46 may be implemented as separate dedicated processors or a single or several processors to provide the function of these tools. As further shown in FIG. 7, one or more RXs 204-1 through 204-X may be connected to the target location determination component 46 such that the signal received by each RX 204 is transferred to the target location determination component 46, which in turn, runs the processes and analysis described herein to localize target locations. The target location determination component 46 may then output information to the components of the computing device 14 to display and/or store the results of the analysis. While executing the computer program code, the processor 20 can read and/or write data to/from memory 22A, storage system 22B, and/or I/O interface 24. Storage system 22B can include information associated with the cache, as described herein. The program code executes the processes of the invention, which can be provided as a computer program product stored on the computer readable storage medium. The bus 26 provides a communications link between each of the components in computing device 14.

The computing device 14 can comprise any general purpose computing article of manufacture capable of executing computer program code installed thereon e.g., a personal computer, server, etc.). However, it is understood that computing device 14 is only representative of various possible equivalent-computing devices that may perform the processes described herein. To this extent, in embodiments, the functionality provided by computing device 14 can be implemented by a computing article of manufacture that includes any combination of general and/or specific purpose hardware and/or computer program code. In each embodiment, the program code and hardware can be created using standard programming and engineering techniques, respectively.

Similarly, server 12 is only illustrative of various types of computer infrastructures for implementing the invention. For example, in embodiments, server 12 comprises two or more computing devices e.g., a server cluster) that communicate over any type of communications link, such as a network, a shared memory, or the like, to perform the process described herein. Further, while performing the processes described herein, one or more computing devices on server 12 can communicate with one or more other computing devices external to server 12 using any type of communications link. The communications link can comprise any combination of wired and/or wireless links; any combination of one or more types of networks e.g., the Internet, a wide area network, a local area network, a virtual private network, etc.); and/or utilize any combination of transmission techniques and protocols.

As described herein, if one of two closely situated TXs has LoS to a target, then it is highly likely that the other does as well. Similarly, if one of the TXs has no LoS to the target, it is highly likely that the other TX also has no LoS. In other words, the DP blocking probabilities for the different TX-RX pairs (TRPs) at a (potential) target location are, in general, correlated and the extent of correlation may be a function of the relative positions of the TXs and RXs with respect to the target location. This is the phenomenon of correlated blocking and it can be used to improve the reliability of target localization in accordance with aspects of the present invention. Aspects of the present invention, as described in greater detail below, may extract MPCs from impulse responses at TRPs, estimate a probability of blockage between prospective target locations and the plurality of TRPs, and determine that a potential target location is an actual target locations based on the estimated probability of blockage.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed:

1. A method comprising:
receiving, by a computing device, radar data from a plurality of TX-RX pairs (TRPs);
generating, by the computing device, a plurality of first ellipses representing a first portion of the received radar data;
determining, by the computing device, a blocking likelihood at a point of intersection between the plurality of first ellipses;
generating, by the computing device, a new or additional ellipse representing a second portion or remainder of the received radar data; and
updating, by the computing device based on generating the new or additional ellipse, the blocking likelihood at the point of intersection between the first plurality of ellipses.

2. The method of claim 1, wherein the intersection between the plurality of first ellipses represents a potential target location.

3. The method of claim 2, further comprising:
determining whether the blocking likelihood at a point of intersection between the plurality of first ellipses satisfies a threshold;
determining that the point of intersection between the plurality of first ellipses is a potential target location when the blocking likelihood satisfies the threshold; and
determining that the point of intersection between the plurality of first ellipses is not a potential target location when the blocking likelihood does not satisfy the threshold.

4. The method of claim 1, further comprising:
generating a blocking likelihood at a point of intersection between the new or additional ellipse and one or more of the plurality of first ellipses; and
storing or outputting information regarding the blocking likelihood and the point of intersection between the new or additional ellipse and one or more of the plurality of first ellipses.

5. The method of claim 1, wherein the radar data includes multipath components (MPCs) and each ellipse of the first plurality of ellipses or the new or additional ellipse represents the MPCs.

6. The method of claim 1, wherein determining the blocking likelihood or updating the blocking likelihood is based on the expression −log [symbol] (kₜ) in which kₜ is a blocking vector.

7. The method of claim 1, wherein receiving the radar data from the plurality of TRPs includes filtering signals using a background cancellation technique.

8. The method of claim 1, further comprising compensating for noise corruption by identifying the point of intersection based on the point being within a threshold distance between the first plurality of ellipses.

9. A computer program product for identifying target locations in a distributed radar system, the computer program product comprising a computer readable storage medium having program instructions embodied therewith, the program instructions executable by a computing device to cause the computing device to:
select two of a plurality of TX-RX pairs (TRPs) in the distributed radar system;
generate a plurality of first ellipses representing radar data received from the selected TRPs;
determine a blocking likelihood at a point of intersection between the plurality of first ellipses;
generate a new or additional ellipse representing radar data received from an additional TRP of the plurality of TRPs; and
update, based on generating the new or additional ellipse, the blocking likelihood at the point of intersection between the first plurality of ellipses.

10. The computer program product of claim 9, wherein the intersection between the plurality of first ellipses represents a potential target location.

11. The computer program product of claim 10, wherein the program instructions further cause the computing device to:
determine whether the blocking likelihood at a point of intersection between the plurality of first ellipses satisfies a threshold;
determine that the point of intersection between the plurality of first ellipses is a potential target location when the blocking likelihood satisfies the threshold; and
determine that the point of intersection between the plurality of first ellipses is not a potential target location when the blocking likelihood does not satisfy the threshold.

12. The computer program product of claim 9, wherein the program instructions further cause the computing device to:
generate a blocking likelihood at a point of intersection between the new or additional ellipse and one or more of the plurality of first ellipses; and
store or output information regarding the blocking likelihood and the point of intersection between the new or additional ellipse and one or more of the plurality of first ellipses.

13. The computer program product of claim 9, wherein determining the blocking likelihood or updating the blocking likelihood is based on the expression: −log [symbol] (kₜ) in which kₜ is a blocking vector.

14. The computer program product of claim 9, wherein receiving the radar data from the plurality of TRPs includes filtering signals using a background cancellation technique.

15. The computer program product of claim 9, wherein receiving the radar data from the plurality of TRPs includes receiving orthogonal signals from the TRPs.

16. A system comprising:
a CPU, a computer readable memory and a computer readable storage medium associated with a computing device;
program instructions to generate a plurality of first ellipses representing multipath components (MPCs) extracted from a plurality of TX-RX pairs (TRPs);
program instructions to determine a blocking likelihood at a point of intersection between the plurality of first ellipses;
program instructions to generate a new or additional ellipse representing MPCs extracted from an additional TRP of the plurality of TRPs;
program instructions to update, based on generating the new or additional ellipse, the blocking likelihood at the point of intersection between the first plurality of ellipses;
program instructions to determine correlated blocking information; and
program instructions to store or output information regarding the blocking likelihood and the point of intersection between the first plurality of ellipses, wherein the correlated blocking information, the blocking likelihood, or the point of intersection between the first plurality of ellipses are used to localize one or more targets;
wherein the program instructions are stored on the computer readable storage medium for execution by the CPU via the computer readable memory.

17. The system of claim 16, further comprising:
program instructions to determine whether the blocking likelihood at a point of intersection between the plurality of first ellipses satisfies a threshold;
program instructions to determine that the point of intersection between the plurality of first ellipses is a potential target location when the blocking likelihood satisfies the threshold;
program instructions to store or output information indicating that the point of intersection is a potential target location;
program instructions to determine that the point of intersection between the plurality of first ellipses is not a potential target location when the blocking likelihood does not satisfy the threshold;
program instructions to store or output information indicating that the point of intersection is not a potential target location.

18. The system of claim 16, further comprising:
program instructions to generate a blocking likelihood at a point of intersection between the new or additional ellipse and one or more of the plurality of first ellipses; and
program instructions to store or output information regarding the blocking likelihood and the point of intersection between the new or additional ellipse and one or more of the plurality of first ellipses.

19. The system of claim 16, wherein determining the blocking likelihood or updating the blocking likelihood is based on the expression: −log [symbol] (kₜ) in which kₜ is a blocking vector.

20. The system of claim 16, further comprising:
program instructions to extract the MPCs from impulse responses at the plurality of TRPs;
program instructions to estimate a probability of blockage between prospective target locations and the plurality of TRPs; and
program instructions to determine that the potential target location is an actual target locations based on the estimated probability of blockage.
